(19) United States
(12) Patent Application Publication
(10) Pub. No.: US 2004/0151888 A1
(43) Pub. Date: Aug. 5, 2004

(54) Duct board having a facing with aligned fibers

(76) Inventors: John O. Ruid, Schwenksville, PA (US); Richard Duncan, Royersford, PA (US)

Correspondence Address: DUANE MORRIS, LLP, IP DEPARTMENT, ONE LIBERTY PLACE, PHILADELPHIA, PA, 19103-7396, US

(21) Appl. No.: 10/757,893

(22) Filed: Jan. 15, 2004

Related U.S. Application Data
(63) Continuation-in-part of application No. 10/141,595, filed on May 8, 2002.

(51) Int. Cl. B32B 27/04

(52) U.S. Cl. 428/298.1

(57) ABSTRACT

A duct board material comprises a substantially rigid fiber glass board having an interior surface and an exterior surface, an exterior facing adhered to the exterior surface, and a bonded, non-woven mat facing adhered to the interior surface. The mat has a plurality of parallel or substantially parallel fibers oriented in a longitudinal direction of the duct board material.

This application is a continuation-in-part of U.S. application Ser. No. 10/141,595, filed May 8, 2002.

### FIELD OF THE INVENTION

The present invention relates to construction materials generally, and more specifically to duct board materials.

### BACKGROUND OF THE INVENTION

Glass fiberboard is used in a variety of applications. One particular use of glass fiberboard is in the construction of lightweight duct board, which is used to fabricate air ducts for heating and cooling systems. Fiber glass duct board has many advantages over metal duct materials, including its insulating characteristics, its acoustical properties, weight, and ease of handling and cutting.

Duct board is sold based on its stiffness, as measured by the product of the elastic modulus E (also referred to as Young's modulus) and the area moment of inertia I. This product is also referred to as EI. The EI product determines a material's resistance to bending. One common thickness for duct board is about 2.5 centimeters (1 inch). Duct board material of 2.5 centimeter thickness is commonly available with an EI of 475 pound-inch², and is also available with an EI of 800 pound-inch². Duct board material of 3.8 centimeters thickness is commonly available with an EI of 800 pound-inch². The advertised EI for any duct board product is a critical specification for which compliance is essential.

Typically, the EI specification is met by increasing the fiber board density to the point where the board is sufficiently stiff. For example, EI 800 duct board materials are commonly used in commercial applications, which require greater stiffness than residential construction.

Typical duct board materials include an outer facing, which may be a vapor barrier, such as foil-scrim-kraft (FSK).

In some duct board materials, a mat facing has been added to the interior surface of the duct board. For example, “TOUGHGARD™” duct board manufactured by Saint-Gobain CertainTeed Corp. of Valley Forge, Pa. has a non-woven mat material on its interior (air stream) surface. The mat prevents erosion of the interior duct board surface at high air flow velocities, thus increasing the maximum flow rate allowed through the duct, and improving the air quality. Although fiber glass material does not foster growth of bacteria or mold, dust and dirt from the heating, ventilation and air conditioning (HVAC) system that settles on the interior surface of the duct board may provide a source of nutrients for mirobiological growth. The interior mat facing of the “TOUGHGARD™” duct board has a biocide to obviate this problem.

An improved duct board material is desired.

### SUMMARY OF THE INVENTION

In some embodiments, a duct board material comprises a substantially rigid fiber glass board having an interior surface and an exterior surface, an exterior facing adhered to the exterior surface, and a bonded, non-woven mat facing adhered to the interior surface. The mat has a plurality of parallel or substantially parallel fibers oriented in a longitudinal direction of the duct board material.

In some embodiments, a duct board material comprises a substantially rigid fiber glass board having an interior surface and an exterior surface, an exterior facing adhered to the exterior surface, and a plurality of parallel or substantially parallel fibers oriented in a longitudinal direction of the duct board material and adhered to the interior surface.

### BRIEF DESCRIPTION OF THE DRAWINGS

FIG. 1 is a cross sectional view of an exemplary embodiment of a duct board material according to an aspect of the present invention.

FIG. 2 is a diagram of an apparatus for forming the duct board material shown in FIG. 1.

FIG. 3 is a flow chart diagram of a process for forming the exemplary duct board material of FIG. 1.

FIG. 4 is a diagram of a portion of a duct fabricated with the duct board material of FIG. 1.

FIG. 5 is a diagram of an apparatus for forming a variation of the duct board material.

FIG. 6 is a diagram of an apparatus for forming another variation of the duct board material.

FIG. 7 is a diagram of another variation of the duct board material.

### DETAILED DESCRIPTION

U.S. application Ser. No. 10/141,595, filed May 8, 2002, is incorporated by reference herein in its entirety, as though fully set forth below.

The inventor has determined that non-woven facing can be applied to fiber glass duct board material of a significantly reduced density, reducing duct board weight while maintaining compliance with stiffness (EI) specifications. In other words, for a duct board material having relatively stiff facings on both the interior and exterior sides thereof, the density of the fiber glass board core can be reduced significantly from the density of an unfaced duct board material having the same minimum stiffness requirement.

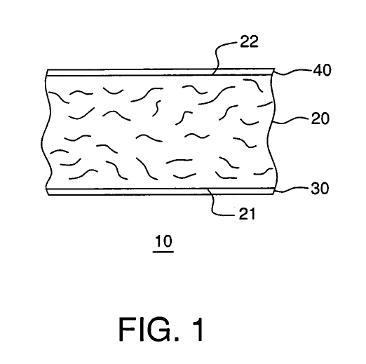

FIG. 1 is a cross sectional view of an exemplary duct board material 10. The material 10 comprises a substantially rigid fiber glass board 20 having an interior surface 21 and an exterior surface 22. The substantially rigid fiberglass board 20 has a density that is less than 69.9 kilograms/meter³ (4.36 lb./foot³) and greater than or equal to about 54.1 kilograms/meter³ (3.38 lb./foot³). For a 2.54 centimeter board 20 of this density range with an EI 475 rating, the mass per unit area is less than 0.1776 grams/centimeter² (165 grams/foot²) and greater than or equal to about 0.1378 grams/centimeter² (128 grams/foot²).

An exterior facing 40 is adhered to the exterior surface 22. A preferred exterior facing is Foil-Scrim-Kraft material (FSK). This material improves the strength of the duct board material and provides a vapor barrier.

A bonded, non-woven mat facing 30 is adhered to the interior surface 21. A preferred material for the non-woven mat facing 21 includes glass filaments in a resinous binder. More preferred materials include a thin, bonded, nonwoven fiber glass mat oriented in a random pattern, having sized glass fibers bonded with a resinous binder. An exemplary mat is formed of randomly oriented glass fibers about 3.2 centimeters long bonded in a process similar to that used for making paper. Thinner mat materials are preferred, because they allow better penetration of the adhesive that bonds the mat 40 to fiber board 20.

An example of a preferred material for the non-woven mat facing 30 is “DURA-GLASS®” 8440 fiber reinforced plastic mat, manufactured by Johns Manville of Toledo, Ohio. The exemplary non-woven mat facing 30 has a thickness of about 0.033 centimeter (0.013 inch). This material has a mass per unit area of about 38.8 grams/meter² (0.13 ounce/foot²).

The duct board material 10 has an elastic modulus-moment of inertia product (EI) of at least 475 pound-inch². Some preferred embodiments have an EI of about 475 pound-inch², and other preferred embodiments have an EI of at least 800 pound-inch². EI 475 materials are suitable for most residential duct applications. EI 800 materials are more commonly used for commercial construction, where higher pressure and greater air velocity is more common, but they can also be used in residential construction.

The exemplary duct board material 10 may be formed with a variety of thicknesses. A typical thickness for EI 475 duct board material 10 is about 2.54 centimeters (1.0 inch). A typical thickness for EI 800 duct board material 10 is 3.81 centimeters (1.5 inches). EI 800 duct board material is also commonly made with a thickness of about 5.1 centimeters (2 inches).

Advantageously, the exemplary duct board material 10 can be formed in the same sizes and shapes as the prior art materials, but has significantly reduced density in the fiber glass board layer 20 while satisfying the same EI specifications as the prior art materials. This reduction in density provides benefit of weight reduction and cost reduction, and improved ease of handling and cutting. Also, it is possible to produce duct board material 10 significantly faster than prior art duct board materials, using the same equipment.

In some preferred embodiments, the density of the rigid fiberglass board 20 is less than or equal to about 62.6 kilograms/meter³ (3.91 lb./foot³) and greater than or equal to about 54.1 kilograms/meter³ (3.38 lb./foot³). For a 2.54 centimeter duct board 10 of this density range, the mass per unit area of the rigid fiberglass board is less than or equal to about 0.1593 grams/centimeter² (148 grams/foot²) and greater than or equal to about 0.1378 grams/centimeter² (128 grams/foot²).

In other preferred embodiments, the density of the rigid fiberglass board is less than or equal to about 57.1 kilograms/meter³ (3.57 lb./foot³) and greater than or equal to about 54.1 kilograms/meter³ (3.38 lb./foot³). For a 2.54 centimeter duct board 10 of this density range, the mass per unit area of the rigid fiberglass board is less than or equal to about 0.1453 grams/centimeter² (135 grams/foot²) and greater than or equal to about 0.1378 grams/centimeter² (128 grams/foot²).

Some preferred embodiments include duct board material, comprising a rigid fiber glass board having an interior surface and an exterior surface, the rigid fiberglass board having a density that is less than 69.9 kilograms/meter³ (4.36 lb./foot³); an exterior facing adhered to the exterior surface; and a bonded, non-woven mat facing adhered to the interior surface, wherein the duct board material has an EI of at least 475 pound-inch². Thus, the thickness of the duct board material 10 is not limited to 2.5 centimeters, the EI may be much greater than 475 pound-inch² (and may be greater than 800 pound-inch²), and the density can be substantially less than 48 kilograms/meter³ (3 lb./foot³).

For example, faced 3.8 centimeter duct boards 10 have been fabricated with density of 3.03 lb./foot³. The EI of this duct board was 1206 (see Table 1 below). For a homogeneous (unfaced) duct board, the moment of inertia (the I component of EI) is proportional to the third power of the thickness. Thus, for duct boards having a given mass per unit area, the thicker duct board has the greater EI. When a relatively stiffer layer, such as the non-woven mat facing 30, is added to the interior face 21 (or exterior face 22), the resistance of the board 10 to deflection is greatly enhanced.

The increase in the overall “composite EI” due to the presence of the facing 30 has a location-dependent component that is approximately proportional to the square of the distance between the neutral axis (which is approximately the centroid) and the layer 30. As a result, increasing the displacement of the non-woven layer from the neutral axis by 50% (e.g., going from a 2.5 centimeter duct board to a 3.8 centimeter duct board) causes a 225% increase in the stiffening contribution caused by displacement of the non-woven mat from the neutral axis. Similarly, increasing the displacement of the non-woven layer from the neutral axis by 100% (e.g., going from a 2.5 centimeter duct board to a 5.1 centimeter duct board) causes a 400% increase in the stiffening contribution caused by displacement of the non-woven mat from the neutral axis.

Consequently, when a thicker fiber board layer 20 (e.g., 3.8 or 5.1 centimeter materials) is combined with the non-woven mat 30, the density of the fiber board layer can be even lower than the 3.0 lb./ft3 density in entry 14 of table 1. The density may be lowered to a point where the EI slightly exceeds 800 pound-inch², for an EI 800 product. Alternatively, the density could be decreased even further for EI 475 products.

A variety of other thin, stiff, porous facings may be used for interior facing layer 30. For example, the “TOUGHGARD™” duct board material mentioned above has a wet laid fiber glass non-woven mat containing an Environmental Protection Agency (EPA) registered biocide and an acrylic binder, with about 25% binder by weight. A similar facing material can be substituted for the preferred non-woven mat 30 described above. This material may have a thickness of, for example, 0.071 centimeter (0.028 inch), and a weight/square of 98 grams/m² (9.1 grams/ft²). Thicker non-woven layers may allow further reduction in the density of the fiber glass layer 20, but thinner layers have advantages in processing, as discussed further below.

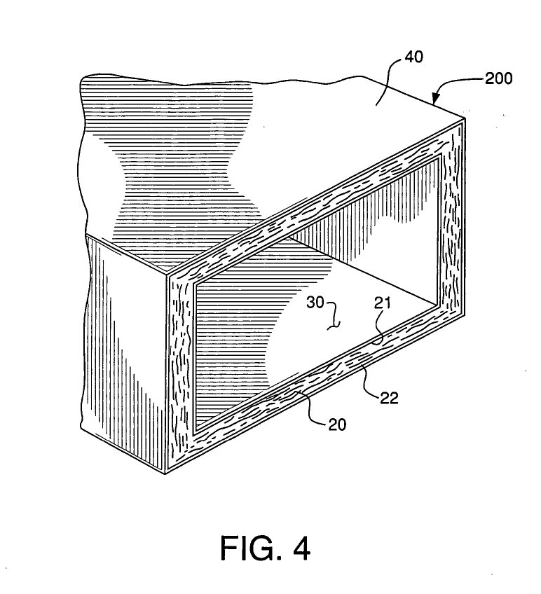

FIG. 4 shows a duct 200 fabricated from the above-described material having a fiberglass layer 20, an interior facing 30 on the inner surface 21 of the fiber glass 20, and an exterior facing 40 on the exterior surface 22 of the fiber glass 20. Although a rectangular duct 200 is shown, ducts of any desired cross section may be constructed using the materials described herein.

Another aspect of the invention is a method of making a duct board material 10. One exemplary method includes forming a rigid fiber glass board 20 having a first thickness and interior and exterior surfaces 21 and 22 using a processing apparatus 100 having a line speed. A bonded, non-woven mat facing 30 is adhered to the interior surface 21 of the fiber glass board material 20. An exterior facing 40 is adhered to the exterior surface 22, such that the duct board material 10 has an elastic modulus-moment of inertia (EI) product of at least 475 pound-inch². In the exemplary method, the conveyor 120 of the processing apparatus 100 is run at a line speed approximately 1.14 to 1.27 times faster than the line speed used to fabricate a duct board having an EI product of at least 475 pound-inch² and having approximately the same first thickness without adhering the non-woven mat facing 30 to the interior face of the duct board.

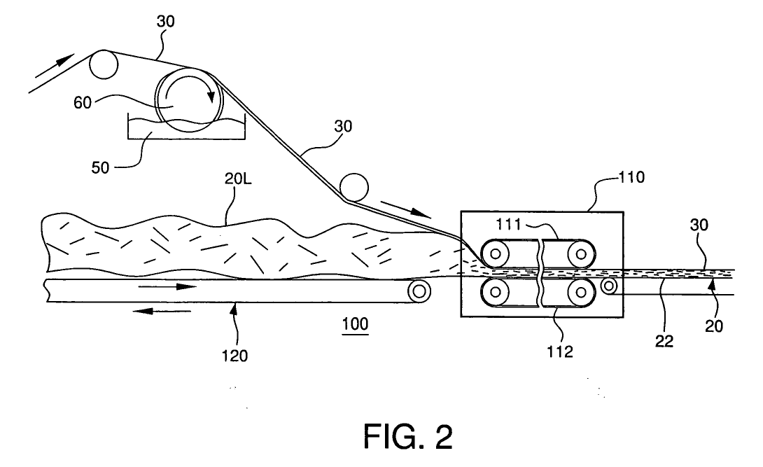

FIG. 2 shows an apparatus 100 for packing the loose fiber glass material 20L into the fiber board layer 20. The glass layer 20 is constructed from a low density fibrous glass wool. The glass fibers may be formed by a rotary process, in which glass from a furnace (not shown) enters rotary spinners (not shown), where the glass is formed into long fibers in a loose glass wool 20L, and the fibers are coated with a resin binder, such as phenol urea formaldehyde (PUFA), for example in a spraying process. The fibers are loaded onto a conveyor 120 and delivered to the curing oven 110. The fiber board layers 20 are formed by compressing the blankets of resin coated glass fibers 20L from an initial thickness of about 25 centimeters to an appropriate thickness and density and curing the resin binder. The compression is performed using two conveyor flights 111 and 112. Typically, the curing step includes blowing hot air through the blanket 20L.

Assuming that the fibers emerge from the rotary spinning apparatus (not shown) at a relatively constant mass flow rate, the mass per unit area is controlled by the line speed of oven flights 111 and 112, and the density is a function of the line speed and the spacing between flights 111 and 112 (i.e., the board thickness). For a constant board thickness, the conveyor speed of flights 111 and 112 determines density. Therefore, less dense duct board materials can be produced at a higher speed.

The inventor has also determined that the exemplary duct board material 10 can be fabricated more easily than prior art materials, because of its “tacking” ability.

The non-woven mat 30 is applied to the interior surface 21 before the loose fiber glass 20L enters the oven 110. Adhesive 50 is applied to the mat 30 as a rate sufficient to penetrate the mat 30. The penetrated adhesive 50 “tacks” the mat 30 to the top oven flight 111. The exterior side 22 of the fiber board layer 20 (bottom in FIG. 2) is made smooth, so that the exterior facing (e.g., FSK) 40 can be applied and readily adhered. The smooth surface of exterior side 22 is formed by running top flight 111 and bottom flight 112 at different speeds. The exterior surface 22 (the side to be made smooth) is “skidded” in the curing oven 110. That is, the surface 22 moves relative to the bottom flight 112. When the packed fiberglass layer 20 and mat 30 emerge from the curing oven 110, the top flight 111 peels away from the top of the mat 30.

Some mat materials are slippery and do not readily allow penetration of the adhesive 50. Such materials would tend to slide easily over the top flight 111 in the curing oven 110. The inventor has determined that a thin, porous material 30 tacks to the top flight 111 better than a thick, non-porous material. With a thin, porous mat material 30 such as the exemplary 0.033 centimeter “DURA-GLASS®” 8440 material described above, the mat readily tacks or temporarily adheres to the flight 111 that contacts mat 30. Another factor that influences the tacking is the surface tension and viscosity of the resin that tacks the mat 30 to the flight 111.

A quantitative measure that is related to the adhesive penetration is the air permeability of the facing 30. A facing material 30 having a higher air permeability is correlated with better penetration of adhesives. Also, the viscosity of the adhesive may affect the adhesive penetration. A resin that is too viscous may not penetrate sufficiently to provide the desired tacking.

The air permeability of the 8440 non-woven material described above on average is about 1002.5 cubic feet per minute per square foot at a pressure differential of 0.5 inch of water. (That is, the flow rate of air through the material with a pressure drop of 0.5 inch of water across the mat). Other materials having greater or lesser permeability may be used. A material having a permeability of 520.5 cubic feet per minute per square foot at a pressure differential of 0.5 inch of water has been demonstrated to provide acceptable results.

Although the exemplary process tacks the mat 30 to the top flight 111, for some products, it is also contemplated that the mat can be tacked to the bottom flight 112, and that the top surface can be skidded across the top flight to form a smooth top surface.

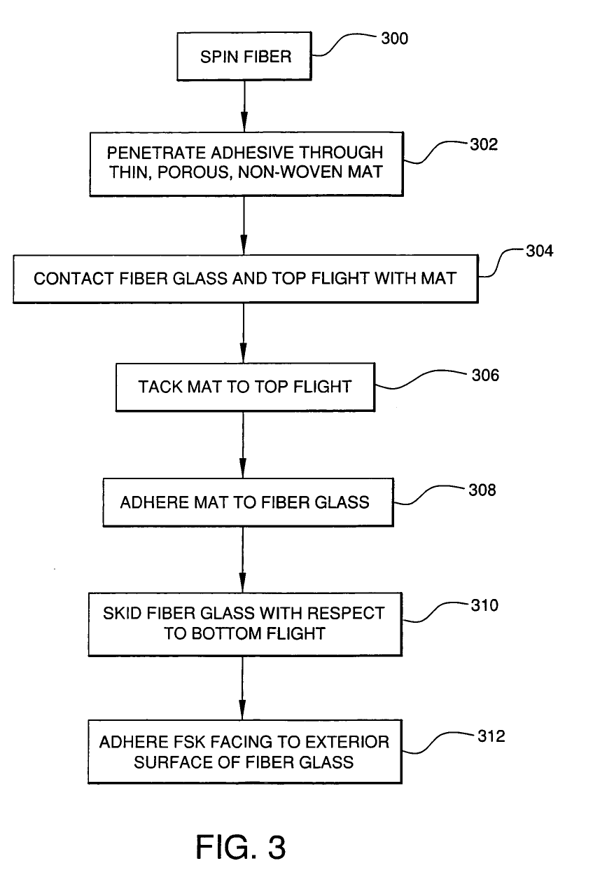

FIG. 3 is a flow chart diagram of the exemplary process.

At step 300, the rigid fiber glass board 20 is formed by spinning fiber that is fed via conveyor 120 to the curing oven 110.

At step 302, an adhesive 50 is penetrated through the thin, porous, non-woven mat facing 30. (In some embodiments, the adhesive may be coated on the non-woven mat facing 30 without complete penetration.).

At step 304, the non-woven mat facing is contacted with the interior surface of the fiber glass board and a portion 111 of the first conveyor.

At step 306, the adhesive 50 tacks the mat 30 to the portion 111 of the first conveyor.

At step 308, the bonded, non-woven mat facing 30 is adhered to the interior surface 21.

At step 310, the fiber glass board 20 skids with respect to a portion 112 of a second conveyor contacted by the exterior surface 22, to form a smooth exterior surface 22.

At step 312, the exterior facing 40 (e.g., FSK) is adhered to the now-smooth exterior surface 22.

### Experimental Data

Table 1 shows results from several experiments performed on a variety of exemplary duct board materials.

TABLE 1

| | | Line | | | | EI |
|---|---|---|---|---|---|---|
| | | Speed | Thickness | mass/area | density | (pound- |
| No. | Facing | (ft/min) | (cm) | (gm/ft²) | (lb/ft³) | inch²) |
| 1 | 8440 | 110 | 2.51 | 125 | 3.30 | 334 |
| 2 | None | 92 | 2.59 | 137 | 3.62 | 381 |
| 3 | None | 110 | 2.51 | 117 | 3.09 | 408 |
| 4 | None | 100 | 2.57 | 129 | 3.41 | 423 |
| 5 | 8440 | 103 | 2.39 | 130 | 3.44 | 504 |
| 6 | 8440 | 100 | 2.54 | 128 | 3.38 | 505 |
| 7 | “D” | 92 | 2.49 | 140 | 3.70 | 519 |
| 7 | 8440 | 92 | 2.49 | 137 | 3.62 | 551 |
| 8 | “C” | 92 | 2.54 | 135 | 3.57 | 560 |
| 10 | 8440 | 98 | 2.36 | 138 | 3.65 | 581 |
| 11 | 8440 | 94 | 2.41 | 144 | 3.81 | 585 |
| 12 | 8440 | 90 | 2.44 | 148 | 3.91 | 638 |
| 13 | None | 79 | 2.54 | 175 | 4.63 | 684 |
| 14 | 8440 | 78 | 3.81 | 172 | 3.03 | 1206 |
| 15 | 8440 | 68 | 3.81 | 200 | 3.52 | 1511 |
| 16 | 8440 | 54 | 3.81 | 201 | 3.54 | 1984 |
| 17 | 8440 | 48 | 3.81 | 233 | 4.11 | 2383 |

In Table 1, the 8440 facing is the “DURA-GLASS®” 8440 material referenced above. Material “C” has a finer fiber size of about 13 micrometers. Material “D” has a coarser fiber size of about 16 micrometers.

All of the entries in Table 1 exceeded the EI 475 specification, except for rows 1-4. All of the 3.8 centimeter duct board materials (entries 14-17) exceed the EI 800 specification. Entry 13 represents a 1.0 inch duct board having a density that was typical of unfaced duct boards in the prior art. The inventor has determined that a faced board 10 having a density of 4.63 pounds/ft³ exceeds the EI 475 specification value (EI=684), and that significantly lower densities may be used without compromising the stiffness. All of the entries 5-12 are 1.0 inch duct boards having significantly reduced densities and EI of more than 475 pound-inch².

Advantageously, using the same fiber spinning apparatus 100 as is used to form conventional unfaced duct board, it is possible to run the apparatus at a significantly increased line speed when fabricating the exemplary dual-faced duct board material 10. For example, the unfaced material in entry 13 of Table 1 is packed with a line speed of 24 meters/minute (79 feet/minute). In entry 12, the exemplary material 10 can be formed at a speed of 27 meters per minute (90 feet per minute) and still provide an EI of 638. This represents a 14% increase in line speed over the unfaced material. Even faster line speeds are possible. In entry 6, a line speed of 30 meters per minute (100 feet/minute) is used, and the resulting product has an EI of 505. This represents a 27% increase in line speed over the unfaced material.

An increase in line speed allows the manufacturer to produce more product in the same amount of time on a single machine. This means that in the long term, production requirements can be met with fewer spinning machines. Unneeded machines can be retired, instead of being repaired or replaced at the end of the machine life. Alternatively, the same amount of product can be made in less time on the same machines. This frees up machine time on each packing machine, so that the machines are now available to make other fiber glass products.

Preferably, the adhesive 50 is colored to match the color of the non-woven mat 30, so that penetration of the adhesive through the mat is not noticeable in the final product. For example, if a black mat is used, a black pigment may be added to adhesive 50. Alternatively, for a mat 30 that is near transparent, the adhesive may be colored to match the interior surface 21 of the fiber glass material.

Other Variations

Alternatively, it is contemplated that a non-woven material having a plurality of parallel fibers aligned therein may alternatively be used to increase the overall duct board stiffness in one direction. The other constituents of the duct board material may be the same as or similar to those described above with reference to FIG. 1.

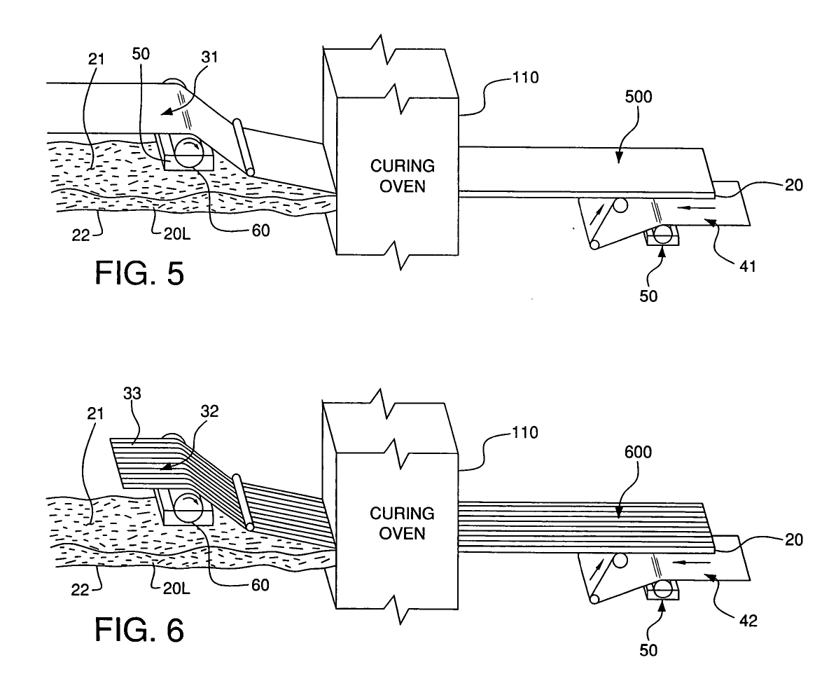

In some embodiments, parallel or substantially parallel aligned fibers are provided by using a nonwoven mat containing fibers oriented predominantly in the machine (longitudinal) direction. For example, as shown in FIG. 5, a fiberglass duct board 500 may comprise: a bound fiberglass board 20 of moderate density (e.g., 3 to 4.5 lbs/ft.³), a first facing 41 (e.g., FSK) adhered to the outside side of the duct, and a second facing 31 comprising a nonwoven mat containing fibers oriented predominantly in the machine direction adhered to the airstream side 21 of the duct board. The MD tensile strength to CD tensile strength ratio may be about 2:1 or more. In some embodiments, mats having highly oriented fibers may have MD to CD ratios between 8:1 and 20:1 in terms of tensile strength, preferably between 12:1 and 20:1. The non-woven mat 31 may be a wet laid non-woven fiber reinforced plastic mat, having a thickness of about 0.033 centimeter (0.013 inch), and a mass per unit area of about 38.8 grams/meter² (0.13 ounce/foot²). By including preferentially oriented fibers, the stiffness of the duct board 500 is increased in the longitudinal direction, to help prevent the duct from sagging along its length.

The exterior facing 41 (e.g., FSK) may be applied to the exterior surface 22 (e.g., using a latex adhesive 50) after the board 20 is formed and cured. The nonwoven facing 31 with parallel fibers may be adhered to the opposite side 21 of the board 20 by a number of techniques, such as:

(1) The non-woven mat 31 may be adhered after the board 20 is formed and cured in the curing oven 110 by applying adhesive 50 (e.g., latex adhesive) to the nonwoven mat 31 or to the board 20 and then laminating the two materials together;

(2) The nonwoven mat 31 may be applied before the board 20 enters the curing oven 110, and may additionally have an adhesive or resin 50 applied to it to improve adhesion; or

(3) The nonwoven mat 31 may be applied after the fiberglass layer 20 with exterior facing 41 thereon has been chopped up, dried and stored for any desired period. (The non-woven material 31 with aligned fibers may be applied in a totally separate operation from forming the duct board 20).

The degree of fiber orientation in nonwovens may be quantified by several methods. Typically the degree of orientation is measured by the ratio of machine direction (MD) to cross-machine direction (CD) properties, such as tensile strength or tear strength. Tensile modulus may also be measured in both directions. In some preferred embodiments, the ratio of MD to CD properties is given by at least 2:1, but other ratios may be used.

In some embodiments, the oriented fibers are not precisely parallel; they are more aligned in the machine direction than in the cross direction. The orientation of the fibers may still have a degree of randomness with a preferential orientation in one direction.

The non-woven mat 31 with oriented fibers, may be made with a paper making process. The fibers are slurried and put on a screen to make a paper-like material. At this point, the fibers may be preferentially oriented in the machine direction. (That is, the fraction of fibers oriented in the machine direction is substantially greater than the fraction of fibers oriented in the machine direction for conventional randomly oriented non-woven mats.) The fibers are oriented by increasing the speed of the machine, increasing the viscosity of slurry, and/or controlling the way the slurry comes out of headbox.

In other embodiments, as shown by duct board material 600 in FIG. 6, the aligned parallel fibers are provided by yarns 33. Continuous strands of yarn 33, such as fiberglass, can be embedded in the non-woven mat 32. The non-woven mat 32 with embedded yarns 33 can be applied to the air stream surface 21 of a duct board material 20 using any of the techniques described above for the non-woven mat 31 with predominantly parallel oriented fibers.

The glass yarns 33 are bunches of fibers that are oriented in the machine direction, and may be continuous multi-filament yarns of types suitable for reinforcements, lining tanks, boat hulls, fiberglass reinforced plastic products and the like. Other yarn materials may be used.

The yarns 33 should be embedded in the non-woven material 32 without slack, so that bending, sagging or longitudinal strain of the duct board 600 places the yarns in tension. (If the yarns 33 have slack, then strain in the duct board 600 will not necessarily place the yarns in tension.) This slack removal ensures that the yarns 33 contribute to the overall longitudinal stiffness of the duct board 600.

An exemplary non-woven mat may comprise a mat about 0.47 mm thick, or thicker, made of 13 μm diameter glass fibers with about 15% thermosetting binder, and glass filament reinforcements spaced about 10 mm apart. In the exemplary non-woven material, due to the addition of the reinforcing fibers, the tensile strength in the machine direction is about twice the tensile strength in the cross machine direction.

Two exemplary commercially available mats 32 with embedded yarns 33 are “MICROLITH®” PM10/3 and PM 10/4 non-woven mats available from Johns Manville Sales GmbH, Wertheim, Germany.

The yarns 33 may be fed in off of spools or spindles (not shown) which contain thousands of yards of yarn. The spools may be held in a creel that feeds them out one by one into the apparatus with a plurality of yarns 33 coming out of it. The yarns 33 end up being parallel and are fed into the paper making process. The yarns 33 may be fed in where the slurry comes out.

Alternatively, the yarns 33 can be wound up on a very large spool, called a warp beam (not shown), which may be 4 or 8 or 10 or 20 feet long, with strands of yarn in it, and then the yarns are fed off of this spool.

In either case, as the yarns 33 are fed from the creel or warp beam, a minimal amount of torque may be applied, sufficient to keep the yarns from feeding in loosely or too quickly.

In other embodiments, the parallel yarns 33 may be added as a separate layer. In some embodiments, the yarns 33 may be placed between the non-woven mat 30 (of FIG. 1) and the fiberglass layer 20. In other embodiments, the yarns 33 may be placed on the interior (air stream) surface of the non-woven mat 30. In either case, an exemplary fabrication method includes applying the parallel yarns 33 to the non-woven facing 30 with an adhesive 50 before applying the non-woven facing 30 to the fiberglass layer 20. The non-woven facing 30, with the attached parallel yarns 33 is then applied to the fiberglass layer 20, with the yarns 33 facing towards or away from the fiberglass 20. In other embodiments, the parallel yarns 33 may be applied over the duct board material 20 shown and described with reference to in FIG. 1.

In some embodiments, for applications in which a vapor barrier is not required, non-woven facing 32 having parallel fibers (preferentially oriented fibers, embedded yarns 33 or surface-mounted yarns) may be applied to both sides of the fiberglass layer 20, and the FSK layer can be omitted. That is, the exterior facing 41 may comprise a bonded, non-woven mat facing having a plurality of parallel fibers oriented in the longitudinal direction of the board material.

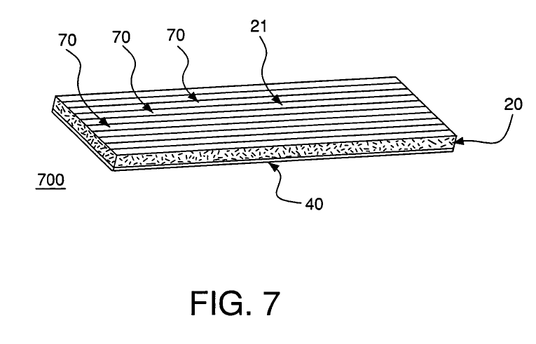

In some embodiments, such as duct board material 700 shown in FIG. 7, the non-woven facing layer is omitted, and a plurality of continuous strands 70 of material (e.g., fiberglass) are applied to the airstream surface 21 of the fiberglass layer 20. The strands 70 are parallel to the length of the duct board 700, so that the strands contribute to the stiffness of the board.

In an exemplary fabrication method, the strands 70 may be continuous filament yarns fed from a warp beam just before the duct board material reaches the curing oven 110. The yarns 70 may be adhered to the board 20 by a number of techniques, such as:

(1) The yarns 70 may be adhered after the board 20 is formed and cured in the curing oven 110 by applying adhesive 50 (e.g., latex adhesive) to the yarns and then applying the yarns to the fiberglass layer;

(2) The yarns 70 may be applied before the board 20 enters the curing oven 110, and may additionally have an adhesive or resin 50 applied to it to improve adhesion; or

(3) The yarns 70 may be applied after the fiberglass layer 20 with FSK 40 thereon has been chopped to length, dried and stored for any desired period. (The yarns may be applied in a totally separate operation from forming the duct board 20).

It will be understood by one of ordinary skill that parallel fibers or various non-woven materials having parallel fibers thereon or embedded therein may be used to enhance the stiffness of the duct board materials, allowing further reduction of the density of the fiber glass duct layer, while maintaining the appropriate stiffness required for EI 475 and EI 800 products.

Although the invention has been described in terms of exemplary embodiments, it is not limited thereto. Rather, the appended claim should be construed broadly, to include other variants and embodiments of the invention, which may be made by those skilled in the art without departing from the scope and range of equivalents of the invention.

What is claimed is:

1. A duct board material, comprising:
a substantially rigid fiber glass board having an interior surface and an exterior surface;
an exterior facing adhered to the exterior surface; and
a bonded, non-woven mat facing adhered to the interior surface, the mat having a plurality of parallel or substantially parallel fibers oriented in a longitudinal direction of the duct board material.

2. The duct board material of claim 1, wherein the mat facing comprises a plurality of parallel or substantially parallel yarns.

3. The duct board material of claim 2, wherein the plurality of parallel or substantially parallel yarns are embedded in the non-woven mat facing.

4. The duct board material of claim 3, wherein the yarns are embedded in the mat facing without slack.

5. The duct board material of claim 1, wherein the mat facing has a plurality of fibers preferentially oriented in the longitudinal direction.

6. The duct board of claim 5, wherein the mat facing has a ratio of machine direction tensile strength to cross direction tensile strength of at least 2:1.

7. The duct board material of claim 1, wherein the exterior facing is a second bonded, non-woven mat facing having a plurality of parallel or substantially parallel fibers oriented in the longitudinal direction of the duct board material.

8. The duct board material of claim 1, wherein the exterior facing comprises a foil-scrim-kraft layer.

9. The duct board material of claim 1, wherein the non-woven mat facing includes glass filaments in a resinous binder.

10. The duct board material of claim 1, wherein:
the exterior facing comprises a foil-scrim-kraft layer,
the non-woven mat facing includes glass filaments in a resinous binder, and
the mat facing has a plurality of parallel or substantially parallel yarns embedded therein without slack.

11. A duct board material, comprising:
a rigid fiber glass board having an interior surface and an exterior surface;
an exterior facing adhered to the exterior surface; and
a bonded, non-woven mat facing adhered to the interior surface, the mat having a plurality of parallel fibers oriented in a longitudinal direction of the duct board material.

12. A duct board material, comprising:
a substantially rigid fiber glass board having an interior surface and an exterior surface;
an exterior facing adhered to the exterior surface; and
a plurality of parallel or substantially parallel fibers oriented in a longitudinal direction of the duct board material and adhered to the interior surface.

13. The duct board material of claim 12, wherein the parallel or substantially parallel fibers are adhered to the fiber glass board using an adhesive or resin.

14. The duct board material of claim 12, wherein the parallel or substantially parallel fibers are fiber glass yarns.

15. The duct board material of claim 12, wherein the exterior facing is a bonded, non-woven mat facing having a plurality of parallel or substantially parallel fibers oriented in the longitudinal direction of the duct board material.

16. The duct board material of claim 12, wherein the exterior facing comprises a foil-scrim-kraft layer.

17. A method for forming a duct board, comprising the steps of:
(a) forming a substantially rigid fiber glass board having an interior surface and an exterior surface;
(b) adhering an exterior facing to the exterior surface; and
(c) adhering a bonded, non-woven mat facing to the interior surface, the mat facing having a plurality of parallel or substantially parallel fibers oriented in a longitudinal direction of the duct board material.

18. The method of claim 17, wherein the mat facing comprises a plurality of parallel or substantially parallel yarns.

19. The method of claim 18, further comprising forming the non-woven mat facing with the plurality of parallel or substantially parallel yarns embedded therein.

20. The method of claim 19, wherein the step of forming the non-woven mat facing includes removing slack from the yarns.

21. The method of claim 18, wherein the step of forming the non-woven mat facing includes feeding the yarns from one of the group consisting of a warp beam and a creel.

22. The method of claim 17, wherein step (c) is performed before the duct board enters a curing oven.

23. The method of claim 17, wherein step (c) is performed after the duct board exits a curing oven.

24. The method of claim 17, wherein the mat facing has a plurality of fibers predominantly oriented in the longitudinal direction.

25. The method of claim 17, wherein the exterior facing is a second bonded, non-woven mat facing having a plurality of parallel or substantially parallel fibers oriented in the longitudinal direction of the board material.

26. A method for forming a duct board, comprising the steps of:
(a) forming a substantially rigid fiber glass board having an interior surface and an exterior surface;
(b) adhering an exterior facing to the exterior surface; and
(c) adhering a plurality of parallel or substantially parallel fibers to the interior surface, the plurality of parallel or substantially parallel fibers oriented in a longitudinal direction of the duct board material.

27. The method of claim 26, wherein the parallel or substantially parallel fibers are included in a plurality of parallel yarns.

28. The method of claim 26, wherein step (c) includes removing slack from the yarns.

29. The method of claim 26, wherein step (c) includes feeding the yarns from one of the group consisting of a warp beam and a creel.

30. The method of claim 26, wherein step (c) is performed before the duct board enters a curing oven.

31. The method of claim 26, wherein step (c) is performed after the duct board exits a curing oven.
